(19) United States
(12) Patent Application Publication
(10) Pub. No.: US 2009/0119976 A1
(43) Pub. Date: May 14, 2009

(54) Bait bucket having a funnel for cast netting

(76) Inventor: Trevor Allen, Austin, TX (US)

Correspondence Address: Trevor Allen, 2508 Dormarion Lane, Austin, TX, 78703, US

(21) Appl. No.: 11/985,267

(22) Filed: Nov. 14, 2007

(51) Int. Cl. A01K 97/05

(52) U.S. Cl. 43/55

(57) ABSTRACT

The present invention is directed to a bait bucket assembly for retaining bait therein. More specifically, a bait bucket assembly is described that may facilitate transferring bait from a cast net therein while minimizing, if not preventing, undesired egression of the bait from the bait bucket assembly, i.e., the bait “escaping” from the bait bucket. Further, the bait bucket assembly may facilitate desired egression of the bait from the bait bucket assembly, i.e., a user retrieving the bait. The bait bucket assembly comprises a bucket having a funnel to achieve the above. The bait bucket assembly may further comprise a floatation device such that the same may float in water.

### FIELD OF THE INVENTION

The field of the invention relates generally to devices for retaining bait, fish, shrimp, or any aquatic life. More particularly, the present invention is directed to a bait bucket assembly.

### BACKGROUND OF THE INVENTION

For as long as the sport of fishing has existed, anglers have used live bait to catch fish. The use of live bait presents a problem to the angler. The angler needs to keep the live bait in a container so that there is easy access. However, when the bait is kept in a container, it tends to die and become useless to the angler. To that end, bait may be kept in a bait bucket that may be floated in a lake, stream, bay, or any body of water. These bait buckets completely encase the bait inside the buckets. The bait buckets may have included holes through the sidewalls that allow for the free exchange of water inside the bucket with water outside the bucket.

To obtain bait that may be used with the bait bucket, cast nets may be employed. More specifically, a cast net is thrown in such a manner that it spreads out on the water and sinks. The bait, fish, shrimp, or aquatic life may be caught as the net is hauled back in. To that end, it may be desired to provide an improved bait bucket to facilitate transfer of bait from the cast net thereto.

### BRIEF DESCRIPTION OF THE DRAWINGS

FIG. 1 is a simplified side view of a bait bucket assembly having a bucket portion, a funnel, and a flotation device;

FIG. 2 is a simplified side of the bucket portion of the bait bucket assembly, shown in FIG. 1;

FIG. 3 is a perspective view of the bucket portion of the bait bucket assembly, shown in FIG. 1;

FIG. 4 is a simplified side view of the funnel of the bait bucket assembly, shown in FIG. 1; and

FIG. 5 is a simplified side view of a cast net.

### DETAILED DESCRIPTION

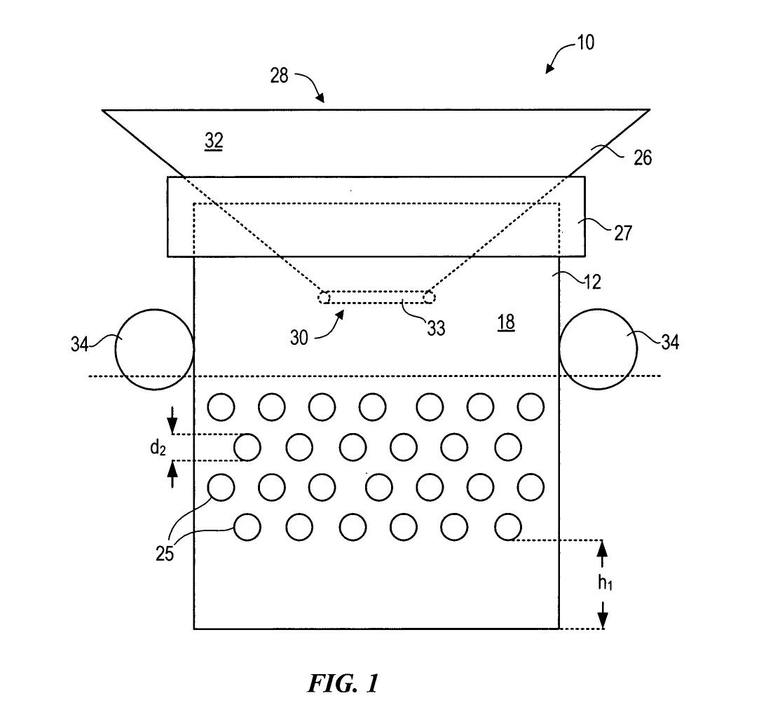

Referring to FIG. 1, a bait bucket assembly 10 is shown. Bait bucket assembly 10 comprises three major components. The first major component of bait bucket assembly 10 is bucket portion 12. Bucket portion 12 may be formed from materials including, but not limited to, plastic, metal, and fiberglass. Bucket portion 12 may comprise any geometrical shape including, but not limited to, conical, cylindrical, and rectangular.

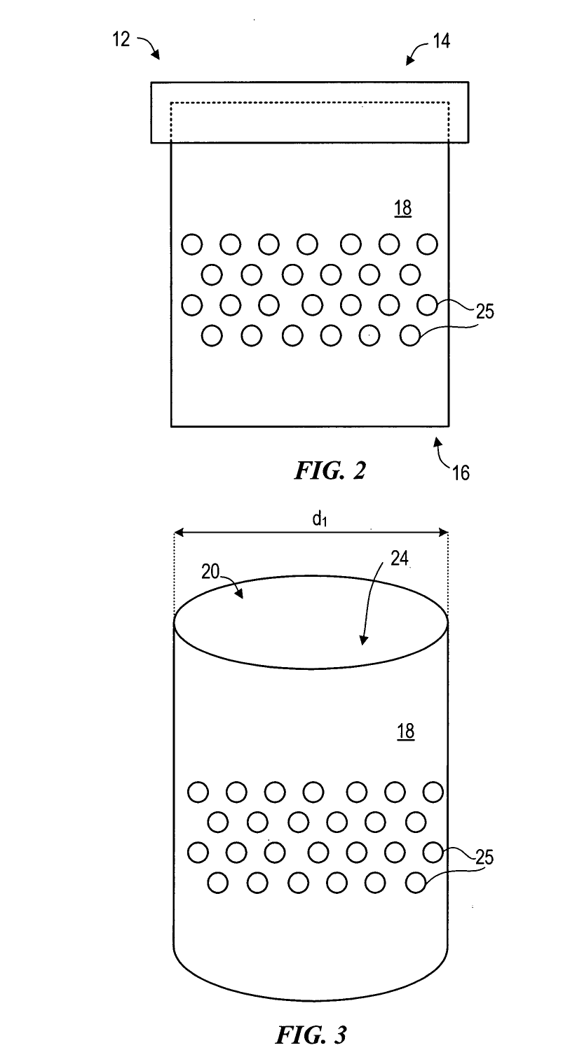

Referring to FIGS. 1 and 2, bucket portion 12 comprises first and second spaced-apart ends 14 and 16 having a wall 18 positioned therebetween. Wall 18 may be any geometrical shape including, but not limited to circular and square. First end 14 may comprise an opening 20. Opening 20 may be any geometrical shape including, but not limited to rectangular and circular. In the present example, opening may have a diameter d₁, shown in FIG. 3. In an example, diameter d₁ may have a magnitude of 11.5 inches. To that end, first and second spaced-apart ends 14 and 16, wall 18 and opening 20 define a cavity 24 for retaining bait. Bait may refer to any aquatic life including, but not limited to, bait, fish, and shrimp.

Referring to FIGS. 1-3, bucket portion 12 may further comprise orifices positioned on wall 18. Orifices 25 facilitate free exchange of water inside bucket portion 12 with water outside of bucket 12 when the same is submerged in water. Orifices 25 may have a diameter d₂ to facilitate the flow of water through bucket portion 12 and minimize, if not prevent, bait from escaping from within cavity 24. In an example, diameter d₂ may have a range of 0.25-0.375 inches. Further, orifices 25 may be positioned a height h₁ from second end 16. In an example, height h₁ may have a value of 5 inches. Bait bucket assembly 10 may further comprise a handle (not shown) proximate to first end 14 which may be employed for transporting bait bucket assembly 10. Bucket portion 12 may comprise a capacity of 3.5 gallons or 5 gallons; however, any capacity may be employed.

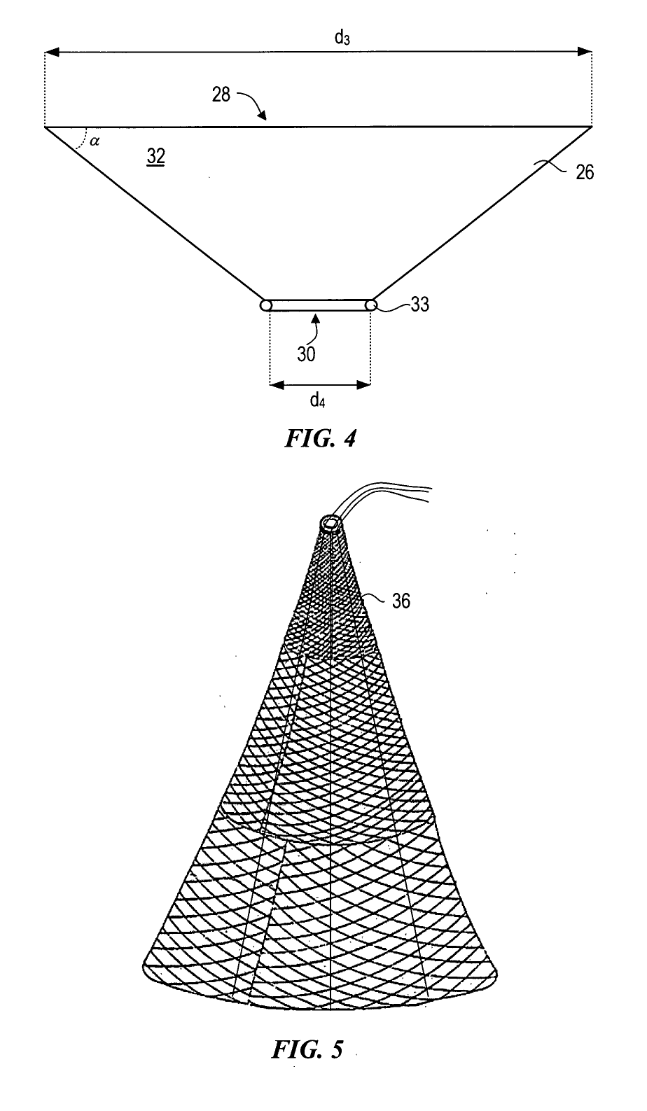

Referring to FIGS. 1 and 4, the second major component of bait bucket assembly 10 is funnel 26. Funnel 26 may comprise first and second spaced-apart apertures 28 and 30 having a wall 32 defined therebetween. An angle α may be defined between a plane of aperture 28 and wall 32, with angle α having a value of approximately 30-45 degrees. In a further embodiment, wall 32 may have a varying slope between first and second spaced-apart apertures 28 and 30 depending on the application desired. First aperture 28 may have a diameter d₃ and second aperture 30 may have a diameter d₄, with diameter d₃ having a greater magnitude than diameter d₄. In an example, diameter d₃ may have a magnitude in a range of approximately 15-20 inches and diameter d₄ may have a magnitude of approximately 4 inches. Funnel 26 may further comprise a rounded lip 33 substantially surrounding second aperture 30. Funnel 26 may be coupled to bucket portion 12 thru said first end 14 of bucket portion 12. In an example, funnel 26 may be fixedly coupled to bucket portion 12 or may be removable coupled to bucket portion 12. Funnel 26 may be thread coupled, fastener coupled, etc., with the type of coupling depending on the type of application desired. In a further example, funnel 26 may be integrally formed with a lid 27, with lid 27 being coupled to bucket portion 12.

Referring to FIG. 1, the third major component of bait bucket assembly 10 is floatation device 34. Floatation device 34 may comprise any geometrical shape including, but not limited to, circular, cylindrical, or rectangular. Floatation device 34 may be constructed or formed from rigid or flexible plastic, metal, fiberglass or a number of different materials. Floatation device 34 may comprise buoyancy such that bait bucket assembly 10 may float in water. Floatation device 34 may be coupled to bucket portion 12 substantially surrounding the same. In a further embodiment, floatation device 34 may be integrally formed with funnel 26.

Referring to FIGS. 1 and 3-5, to that end, bait bucket assembly 10 may facilitate ingress of bait within cavity 24 through opening 20 of bucket assembly 12 while minimizing, if not preventing, undesired egress of the bait thru the same. A cast net 36 may be employed to transfer bait to bait bucket assembly 10, and more specifically, within cavity 24. To that end, cast net 36 may be positioned adjacent to funnel 26, and more specifically, positioned adjacent first aperture 28. Cast net 36 may be opened such that the bait positioned therein may be released therefrom and into funnel 26 and subsequently, as a result of gravity, positioned within cavity 24 of bait bucket 10, as desired. Funnel 26 facilitates transfer of the bait from cast net 36 to cavity 24 as a result of funnel 26 having a conical shape. More specifically, as mentioned above, funnel 26 comprises first and second apertures 28 and 30 having diameters d₃ and d₄, respectively. To that end, as a result of diameter d₄ being less than diameter d₃, as mentioned above, transfer of the bait from cast net 36 to cavity 24 may be facilitated, as desired.

Referring to FIGS. 1, 3, and 5, however, after transfer of the bait from cast net 36 to cavity 24, it may be desired to minimize, if not prevent undesired egress of the bait from bait bucket assembly 10 while facilitating desired egress of the bait from bait bucket assembly 10. More specifically, possible egression of the bait from cavity 24 may be through opening 20 of bait bucket assembly 10. To that end, funnel 26 reduces a diameter of opening 20 by being positioned therein. More specifically, possible egression of the bait positioned within cavity 24 may be through second aperture 30 of funnel 26, with diameter d₄ of second aperture 30 being substantially less than the diameter d₁ of opening 20. As a result, unwanted egression of bait from bait bucket assembly may be minimized, if not prevented. Furthermore, funnel 26 may facilitate desired egression of the bait from cavity 24 as funnel 26 does not require opening of any “gate” to gain entry within cavity 24 by a user.

Moreover, a portion of cast net 36 may become positioned within cavity 24 upon transfer of the bait from cast net 36 to cavity 24. To that end, rounded lip 33 substantially surrounding second aperture 30 may facilitate removal of cast net 36 from within cavity 24.

The embodiments of the present invention described above are exemplary. Many changes and modifications may be made to the disclosure recited above, while remaining within the scope of the invention. Therefore, the scope of the invention should not be limited by the above description, but instead should be determined with reference to the appended claims along with their full scope of equivalents.

What is claimed is:

1. A bait bucket assembly comprising:
a bucket having first and second spaced-apart ends having a wall extending therebetween, said first end having an opening; and
a funnel, having first and second spaced-apart apertures, coupled to said bucket thru said first end, said first aperture having a first diameter and said second aperture having a second diameter greater than said first diameter, with said first aperture spaced-apart from said second end of said bucket a first distance and said second aperture spaced-apart from said second end a second distance greater than said first distance.

2. The bait bucket assembly as described above in claim 1 wherein a magnitude of said first diameter of said first aperture minimizes a probability of unwanted egression of said bait through said opening of said bucket.

3. The bait bucket assembly as described above in claim 1 wherein a magnitude of said second diameter of said second aperture facilitates ingression of said bait.

4. The bait bucket assembly as described above in claim 1 wherein said second aperture is positioned outside of said bucket.

5. The bait bucket assembly as described above in claim 1 wherein said bucket further comprises a plurality of orifices positioned on said wall.

6. The bait bucket assembly as described above in claim 1 further including a floatation device coupled to said bucket.

7. The bait bucket assembly as described above in claim 1 wherein said opening of said first end has a third diameter, with said third diameter being greater than said first diameter.

8. The bait bucket assembly as described above in claim 1 wherein said funnel comprises a rounded lip substantially surrounding said first aperture.

9. The bait bucket assembly as described above in claim 1 wherein said bucket is cylindrical.

10. The bait bucket assembly as described above in claim 1 wherein a portion of said bait bucket assembly is submerged in water.

11. A bait bucket assembly comprising:
a bucket having first and second spaced-apart ends having a wall extending therebetween, said first end having an opening;
a funnel, having first and second spaced-apart apertures, coupled to said bucket thru said first end, said first aperture having a first diameter and said second aperture having a second diameter greater than said first diameter, with said first aperture spaced-apart from said second end of said bucket a first distance and said second aperture spaced-apart from said second end a second distance greater than said first distance; and
wherein a magnitude of said first diameter of said first aperture minimizes a probability of unwanted egression of said bait through said opening of said bucket and a magnitude of said second diameter of said second aperture facilitates ingression of said bait.

12. The bait bucket assembly as described above in claim 11 wherein said second aperture is positioned outside of said bucket.

13. The bait bucket assembly as described above in claim 11 wherein said bucket further comprises a plurality of orifices positioned on said wall.

14. The bait bucket assembly as described above in claim 11 further including a floatation device coupled to said bucket.

15. The bait bucket assembly as described above in claim 11 wherein said opening of said first end has a third diameter, with said third diameter being greater than said first diameter.

16. The bait bucket assembly as described above in claim 11 wherein said funnel comprises a rounded lip substantially surrounding said first aperture.

17. The bait bucket assembly as described above in claim 11 wherein said bucket is cylindrical.

18. The bait bucket assembly as described above in claim 11 wherein a portion of said bait bucket assembly is submerged in water.
